(19) United States
(12) Patent Application Publication
(10) Pub. No.: US 2006/0093314 A1
(43) Pub. Date: May 4, 2006

(54) Editing of data frames

(75) Inventors: Declan Patrick Kelly, Eindhoven (NL); Wilhelmus Jacobus Van Gestel, Eindhoven (NL); Steven Broeils Luitjens, Eindhoven (NL); Kero Van Gelder, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/536,838

(22) PCT Filed: Oct. 31, 2003
(86) PCT No.: PCT/IB03/04948

§ 371 Date: May 31, 2005

(30) Foreign Application Priority Data
Dec. 5, 2002 (EP) 020801189

(51) Int. Cl. H04N 5/93

(52) U.S. Cl. 386/52

(57) ABSTRACT

A method and apparatus for editing a recorded data stream is disclosed. A frame number is received from a user interface for an edit point in the recorded data stream selected by a user. An expected presentation timestamp of the selected frame number is calculated. A first predetermined value is added to the expected timestamp to form a first time limit. The first predetermined value is then subtracted from the expected presentation timestamp to form a second time limit, wherein the first and second time limits form a time window. The system then searches for the selected frame at the expected presentation timestamp on a storage device using the time window. The predetermined values are chosen to ensure that only a single frame (the required frame) can have a PTS within the time window.

### FIELD OF THE INVENTION

The invention relates to editing of data frames, and more particularly to a method and apparatus for handling time based inaccuracies of presentation time stamps during manipulation of the data frames.

### BACKGROUND OF THE INVENTION

The development of the large-capacity rewritable media, like DVD+RW or DVD-RW optical discs, offers a unique technology for storing and accessing full motion video data. As this data requires a large amount of storage capacity, various types of video compression algorithms are used to reduce the amount of necessary storage capacity. Generally, these algorithms use a concept referred to as inter-picture compression, which involves storing only the differences between successive pictures in the data file. Inter-picture compression stores the entire image of a key picture or a reference picture, generally in a moderately compressed format. Successive pictures are compared with the key picture, and only the differences between the key picture and the successive pictures are stored. Periodically, such as when new scenes are displayed, new key pictures are stored, and subsequent comparisons begin from this new reference point.

A compression standard referred to as MPEG (Moving Pictures Experts Group) compression is a set of methods for compression and decompression of full motion video pictures which uses the inter-picture compression technique described above. The key, intra-pictures are referred to as I-pictures. The inter-pictures are divided into two groups: inter-pictures coded using only past reference elements which are referred to as P-pictures and inter-pictures coded using a past and/or future reference, referred to as B-pictures.

An embodiment of a method described above is known from published International Patent Application No. WO 00/28544, which teaches how to extract pointers to the I-pictures and to the P-pictures in a sequence of video data. Information concerning these pointers constitutes a sequence of characteristic points information, hereinafter also referred to as a CPI. CPI comprises tables of locations within the recorded streams which are suitable as entry points in case of editing, interactive playback and trick play modes of operation. In general, CPI is used to determine the location of relevant data elements in a clip, without having to read and parse the clip itself For each clip file, there is an accompanying CPI sequence, containing a list of all the characteristic points of that clip. Clip files may be permitted to share data with other clip files to save duplicating data on disc, in a known manner. Similarly, CPI sequences can also share points with other CPI sequences.

Editing of recorded content needs to be supported for digital recording. In order to support this in a recorder, there must be a user interface which allows the user to choose the points at which to edit. A problem with this type of editing is the need for some way to identify the frames selected by the user with the frames stored on the disc.

### SUMMARY OF THE INVENTION

It is an object of the invention to overcome at least part of the above-described deficiencies by providing a method and apparatus for searching for a frame boundary when the timestamp for the frame boundary may be incorrect.

According to one embodiment of the invention, a method and apparatus for editing a recorded data stream is disclosed. A frame number is received from a user interface for an edit point in the recorded data stream selected by a user. An expected presentation timestamp of the selected frame number is calculated. A first predetermined value is added to the expected timestamp to form a first time limit. The first predetermined value is then subtracted from the expected presentation timestamp to form a second time limit, wherein the first and second time limits form a time window. The system then searches for the selected frame at the expected presentation timestamp on a storage device using the time window. The predetermined values are chosen to ensure that only a single frame (the required frame) can have a PTS within the time window.

According to another embodiment of the invention, a method and apparatus for recording and editing a data stream is disclosed. The data stream is received and parsed to find timestamps for each frame of the data stream. It is then determined if the timestamp is correct and any timestamps which are incorrect are then corrected. When a frame number is received from a user interface for an edit point in the recorded data stream selected by a user, an expected presentation timestamp of the selected frame number is calculated. The system then searches for the expected presentation timestamp on a storage device.

According to another embodiment of the invention, a method and apparatus for recording and editing a data stream is disclosed. The data stream is received and parsed to find each CPI in the data stream. The system then determines if the timestamps for frames of the data stream are correct in the CPI, and corrects any timestamps in the CPI which are incorrect. When a frame number is received from a user interface for an edit point in the recorded data stream selected by a user, an expected presentation timestamp of the selected frame number is calculated. The system then searches for the expected presentation timestamp in CPIs of the data stream.

These and other aspects of the invention will be apparent from and elucidated with reference to the embodiments described hereafter.

### BRIEF DESCRIPTION OF THE DRAWINGS

The invention will now be described, by way of example, with reference to the accompanying drawings, wherein:

FIG. 1 illustrates a block diagram of a audio-video apparatus suitable to host embodiments of the invention;

FIG. 2 illustrates a block diagram of a set-top box which can be used to implement at least one embodiment of the invention;

FIG. 3 is a flow chart illustrating a method for accounting for inaccuracies in decoding and presentation times of data streams during recording and editing according to one embodiment of the invention;

FIG. 4 is a flow chart illustrating a method for accounting for inaccuracies in decoding and presentation times of data streams during recording and editing according to one embodiment of the invention; and

FIG. 5 is a flow chart illustrating a method for accounting for inaccuracies in decoding and presentation times of data streams during editing according to one embodiment of the invention.

### DETAILED DESCRIPTION OF THE INVENTION

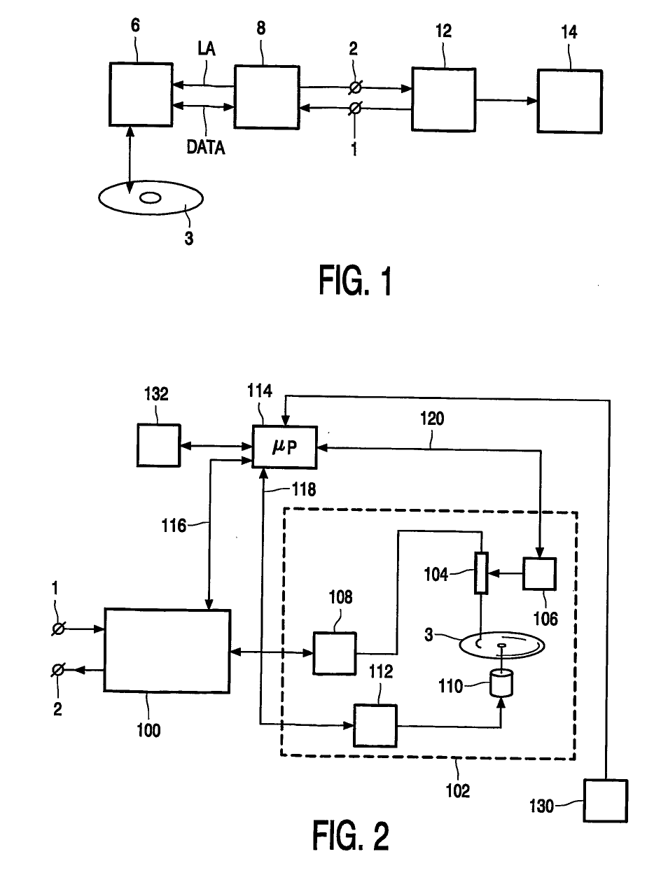

FIG. 1 illustrates an audio-video apparatus suitable to host the invention. The apparatus comprises an input terminal 1 for receiving a digital video signal to be recorded on a disc 3. Further, the apparatus comprises an output terminal 2 for supplying a digital video signal reproduced from the disc. These terminals may in use be connected via a digital interface to a digital television receiver and decoder in the form of a set-top box (STB) 12, which also receives broadcast signals from satellite, cable or the like, in MPEG TS format. The set-top box 12 provides display signals to a display device 14, which may be a conventional television set.

The video recording apparatus as shown in FIG. 1 is composed of two major system parts, namely the disc subsystem 6 and the video recorder subsystem 8, controlling both recording and playback. The two subsystems have a number of features, as will be readily understood, including that the disc subsystem can be addressed transparently in terms of logical addresses (LA) and can guarantee a maximum sustainable bit-rate for reading and/or writing data from/to the disc.

Suitable hardware arrangements for implementing such an apparatus are known to one skilled in the art, with one example illustrated in patent application WO-A-00/00981. The apparatus generally comprises signal processing units, a read/write unit including a read/write head configured for reading from/writing to a disc 3. Actuators position the head in a radial direction across the disc, while a motor rotates the disc. A microprocessor is present for controlling all the circuits in a known manner.

FIG. 2 shows an embodiment of the apparatus in accordance with the invention. The apparatus comprises an input terminal 1 for receiving an information signal and a signal processing unit 100. The signal processing unit 100 receives the video information signal via the input terminal 1 and processes the video information into an information file for recording the information file on the disc 3. The signal processor unit 100 can also send video information to other devices through terminal 2. Further, a read/write unit 102 is available. The read/write unit 102 comprises a read/write head 104, which is in the present example an optical read/write head for reading/writing the information file on/from the disc 3. Further, positioning means 106 are present for positioning the head 104 in a radial direction across the disc 3. A read/write amplifier 108 is present in order to amplify the signal to be recorded and amplifying the signal read from the disc 3. A motor 110 is available for rotating the disc 3 in response to a motor control signal supplied by a motor control signal generator unit 112. A microprocessor 114 is present for controlling all the circuits via control lines 116, 118 and 120.

The signal processing unit 100 is adapted to convert the information signal into an information file. The information file is in the form of a sequence of frames comprising blocks of information of the information file having a specific size. By storing the start/end PTS for each STC Sequence the number of frame in that sequence can be determined and so the frame numbers are implicit. They are generated by the user interface and then mapped to actual frames on disc as described below. The processing unit 100 is further adapted to generate a CPI sequence for the information file. To that purpose, the processing unit is, as an example, capable of identifying the start and end positions of an I-frame in the information file and for generating a block of information for the CPI sequence. The CPI information can be temporarily stored in a memory 132 until the processing of the information signal into the information file (and eventually the subsequent recording on the disc 3) has been completed. Next, the CPI information stored in the memory 132 can be recorded on the disc 3.

In order to enable editing of an information signal recorded in an earlier recording step on the disc 3, the apparatus is further provided with an input unit 130 for receiving edit commands from a user. According to one embodiment of the invention, the user sees the recording as a sequence of frames, e.g., numbered 0 . . . N, where N is the total number of frames in the recording. Thus, the user selects a frame without any knowledge of the underlying format used to store the frames of the recording on the disc 3. The selected frame number is sent to the microprocessor 114 which can forward the information to the signal processing unit 100.

When the user selects a frame number, the frame number must be converted into a timestamp which leads to a location on the disc 3. In digital video recording, by using CPI data structures, timestamps are mapped to locations on the disc. In practice, it is more complicated because timestamps in a recording need not be unique. However, a digital recorder can store a SequenceInfo structure that indicates where the discontinuities occur in the time base. Within each continuous sequence, called an STC sequence, the timestamps are unique. Therefore to identify a frame, one needs to know the STC sequence and the PTS time and then the CPI can be used to find the frame on the disc.

The description of an STC sequence includes the start PTS and the end PTS. The difference between these two timestamps gives the duration of the STC sequence, dividing this time by the frame duration gives the number of frames in the STC sequence. From this, the number of frames in the complete clip can be calculated and so map the clip onto frames 0 to N. On the user interface, the user can be presented with a sequence of frames 0 . . . N to choose for editing. Suppose STC sequence 1 is frames 0 to N1 and STC sequence 2 is frames N1+1 to N2. Then, if frame Z is chosen by the user in the user interface, it will be mapped to an actual frame on the disc 3 as follows. Suppose N1<Z≦N2, then frame Z is in STC sequence 2 and (Z-(N1+1)) gives the frame number of frame Z within the STC sequence 2 (counting from 0). The expected PTS of the frame Z is then (PTS start of the STC sequence 2)+(Z-(N1+1))*frameperiod.

To find the actual frame on the disc 3, the CPI is searched to find two points (I-frames) P1 and P2 such that PTS(P1)≦PTS(Z)<PTS(P2). The CPI points also indicate the location in the file of points P1 and P2 so the required frame Z is stored in the file between P1 and P2. Therefore, these parts of the file can be read and searched for the actual frame Z. Typically, all frames do not include PTSs in the stream so this search will be done by calculating the PTS of the frames between P1 and P2 using the frame period and the relative position after P1. A problem occurs if there are small errors in the presentation timestamps. For example, suppose frame Z equals CPI point P1 but there is an error in the PTS for P1 so that it is a few clock ticks larger than expected. Then the search criteria PTS(P1)≦PTS(Z)<PTS(P2) will not be true as expected. Instead the condition PTS(P0)≦PTS(Z)<PTS(P1) will be true and so the system will search for frame Z between P0 and P1 even though frame Z equals frame P1. Thus, the search will fail and so will the edit operation.

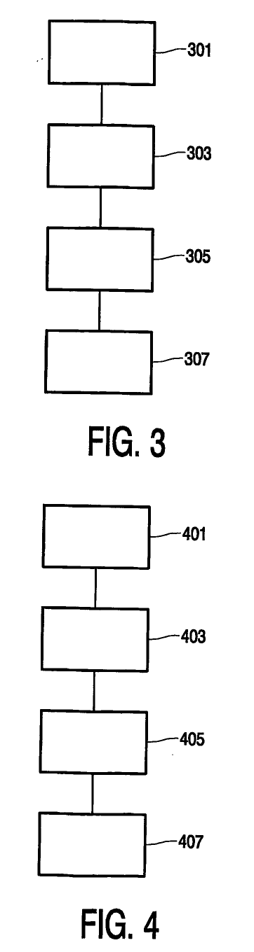

According to one embodiment of the invention, the recorder fixes all presentation timestamps when the information signal is recorded so that the expected timestamps will coincide with the actual stored timestamps. FIG. 3 is a flow chart illustrating the steps of this operation. In step 301, the processing unit 100 receives the information stream which is to be recorded. The information stream is then parsed to find the timestamps for each frame of the information stream in step 303. The processing unit 100 then determines if each timestamp is correct in step 305 and corrects any timestamps which are not correct in step 307. As a result, the actual and expected timestamps should now coincide if the user wants to edit the recording. For example, the editing operation can begin as follows. A user selects an edit point in the recorded data stream using the user interface 130 and a frame number of the edit point is determined by the processing unit 100. An expected presentation time stamp is then calculated for the selected frame. The expected presentation timestamp is then compared with the actual stored timestamps to determine the appropriate stored frame selected by the user.

According to another embodiment of the invention, the recorder corrects all timestamps in a CPI as illustrated in FIG. 4. In step 401, the processing unit 100 receives the information stream which is to be recorded. The information stream is then stored on the disc and CPIs for the recording are created in step 403. The processing unit 100 then determines if the timestamps in each CPI are correct in step 405 and corrects any timestamps which are incorrect in step 407. In this embodiment, the expected timestamps for the selected frame is compared to the timestamps in the CPI while the actual timestamps of the frames which are stored on the disc are ignored. For example, the editing operation can begin as follows. A user selects an edit point in the recorded data stream using the user interface 130 and a frame number of the edit point is determined by the processing unit 100. An expected presentation time stamp is then calculated for the selected frame. The expected presentation timestamp is then compared with the timestamps stored in the CPIs to determine the appropriate stored frame selected by the user.

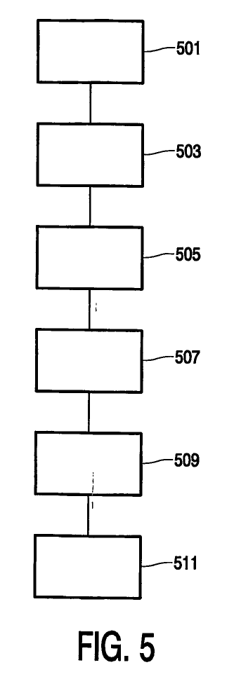

According to another embodiment of the invention, a search window can be used to search for the correct frame on the disc. A method for editing a recorded data stream is illustrated in FIG. 5. A user selects an edit point in the recorded data stream using the user interface 130 and a frame number of the edit point is determined in step 501. An expected presentation time stamp is then calculated for the selected frame in step 503. A predetermined value Δ is then added to the time of the expected presentation timestamp to form a first time limit in step 505. The predetermined Δ value is then subtracted from the time of the expected presentation timestamp to form a second time limit in step 507. It will be understood that a different predetermined value could be subtracted from the expected presentation timestamp to form the second time limit. The first and second time limits are used to form a time window. The value Δ should be less than half the frame period to ensure that only a single (desired) frame will be found within the time limit. The time window around the expected timestamp is then used to search for the selected frame. For example, the CPI can be used to determine the location on disc of the desired frame by finding adjacent entries in CPI with a previous and later timestamp in step 509, taking into account the time window for the case that the required frame is included in the CPI. The desired frame is then on the location on the disc between these two frames. The system can then search the location on the disc 3 identified by the CPI for an actual timestamp which occurs within the time window in step 511.

It will be understood that the different embodiments of the invention are not limited to the exact order of the above-described steps as the timing of some steps can be interchanged without affecting the overall operation of the invention. Furthermore, the term “comprising” does not exclude other elements or steps, the terms “a” and “an” do not exclude a plurality and a single processor or other unit may fulfill the functions of several of the units or circuits recited in the claims.

1. A method for editing a recorded data stream, comprising the steps of:
receiving a frame number from a user interface for an edit point in the recorded data stream selected by a user;
calculating an expected presentation timestamp of the selected frame number;
adding a first predetermined value to the expected timestamp to form a first time limit;
subtracting the first predetermined value from the expected presentation timestamp to form a second time limit, wherein the first and second time limits form a time window; and
searching for the selected frame at the expected presentation timestamp on a storage device using said time window.

2. The method according to claim 1, wherein said second time limit is formed by subtracting a second predetermined value from the expected presentation time.

3. The method according to claim 1, wherein the predetermined value is less than half the frame period.

4. The method according to claim 1, wherein said search step comprises the steps of:
searching for a CPI which contains a timestamp of the expected presentation timestamp; and
searching a location on the storage device identified by the CPI for an actual timestamp which corresponds to the time window.

5. A method for recording and editing a data stream, comprising the steps of:
receiving the data stream;
parsing the data stream to find timestamps for each frame of the data stream;
determining if the timestamp is correct;
correcting any timestamps which are incorrect.

6. The method according to claim 5, further comprising the steps of:
receiving a frame number from a user interface for an edit point in the recorded data stream selected by a user;
calculating an expected presentation timestamp of the selected frame number;
searching for the expected presentation timestamp on a storage device.

7. A method for recording and editing a data stream, comprising the steps of:
receiving the data stream;
parsing the data stream to find each CPI in the data stream;
determining if the timestamps for frames of the data stream are correct in the CPI;
correcting any timestamps in the CPI which are incorrect.

8. The method according to claim 7, further comprising the steps of
receiving a frame number from a user interface for an edit point in the recorded data stream selected by a user;
calculating an expected presentation timestamp of the selected frame number; searching for the expected presentation timestamp in CPIs of the data stream.

9. An apparatus for editing a recorded data stream, comprising:
means for receiving a frame number from a user interface for an edit point in the recorded data stream selected by a user;
calculating means for calculating an expected presentation timestamp of the selected frame number;
means for adding a first predetermined value to the expected timestamp to form a first time limit;
means for subtracting the first predetermined value from the expected presentation timestamp to form a second time limit, wherein the first and second time limits form a time window; and
means for searching for the selected frame at the expected presentation timestamp on a storage device using said time window.

10. The apparatus according to claim 9, wherein said second time limit is formed by subtracting a second predetermined value from the expected presentation time.

11. The apparatus according to claim 9, wherein the predetermined value is less than half the frame period.

12. The apparatus according to claim 9, further comprising:
means for searching for a CPI which contains a timestamp of the expected presentation timestamp; and
means for searching a location on the storage device identified by the CPI for an actual timestamp which corresponds to the time window.

13. An apparatus for recording and editing a data stream, comprising:
means for receiving the data stream;
means for parsing the data stream to find timestamps for each frame of the data stream;
means for determining if the timestamp is correct;
means for correcting any timestamps which are incorrect.

14. The apparatus according to claim 13, further comprising:
means for receiving a frame number from a user interface for an edit point in the recorded data stream selected by a user;
means for calculating an expected presentation timestamp of the selected frame number;
means for searching for the expected presentation timestamp on a storage device.

15. An apparatus for recording and editing a data stream, comprising:
means for receiving the data stream;
means for parsing the data stream to find each CPI in the data stream;
means for determining if the timestamps for frames of the data stream are correct in the CPI;
means for correcting any timestamps in the CPI which are incorrect.

16. The apparatus according to claim 15, further comprising:
means for receiving a frame number from a user interface for an edit point in the recorded data stream selected by a user;
means for calculating an expected presentation timestamp of the selected frame number;
means for searching for the expected presentation timestamp in CPIs of the data stream.
